(19) United States
(12) Patent Application Publication
(10) Pub. No.: US 2025/0150403 A1
(43) Pub. Date: May 8, 2025

(54) EXCHANGING LOCAL ADDRESS INFORMATION FOR PDU SETS OF A MEDIA COMMUNICATION SESSION

(71) Applicant: QUALCOMM Incorporated, San Diego, CA (US)

(72) Inventors: Liangping Ma, San Diego, CA (US); Imed Bouazizi, Celina, TX (US); Nikolai Konrad Leung, San Francisco, CA (US); Thomas Stockhammer, Bergen (DE)

(21) Appl. No.: 18/938,052

(22) Filed: Nov. 5, 2024

Related U.S. Application Data
(60) Provisional application No. 63/596,415, filed on Nov. 6, 2023.

(51) Int. Cl. H04L 47/36; H04L 65/65; H04W 4/10

(52) U.S. Cl. CPC H04L 47/36; H04L 65/65; H04W 4/10

(57) ABSTRACT

An example user equipment (UE) device for exchanging media data via a network includes a memory configured to store media data; and a processing system comprising one or more processors implemented in circuitry, the processing system being configured to: receive data from a second network device via a radio access network (RAN), the data from the second network device including a local Internet protocol (IP) address type for the second network device and a maximum transmission unit (MTU) size for the second network device; establish a media communication session with the second network device; send data representing the local IP address type and the MTU size for the second network device to a gateway device associated with the RAN; and receive packets of a protocol data unit (PDU) set of the media communication session originating from the second network device via the RAN.

This application claims the benefit of U.S. Provisional Application No. 63/596,415, filed Nov. 6, 2023, the entire contents of which are hereby incorporated by reference.

### TECHNICAL FIELD

This disclosure relates to storage and transport of encoded media data.

### BACKGROUND

Digital video capabilities can be incorporated into a wide range of devices, including digital televisions, digital direct broadcast systems, wireless broadcast systems, personal digital assistants (PDAs), laptop or desktop computers, digital cameras, digital recording devices, digital media players, video gaming devices, video game consoles, cellular or satellite radio telephones, video teleconferencing devices, and the like. Digital video devices implement video compression techniques, such as those described in the standards defined by MPEG-2, MPEG-4, ITU-T H.263 or ITU-T H.264/MPEG-4, Part 10, Advanced Video Coding (AVC), ITU-T H.265 (also referred to as High Efficiency Video Coding (HEVC)), and extensions of such standards, to transmit and receive digital video information more efficiently.

Video compression techniques perform spatial prediction and/or temporal prediction to reduce or remove redundancy inherent in video sequences. For block-based video coding, a video frame or slice may be partitioned into macroblocks. Each macroblock can be further partitioned. Macroblocks in an intra-coded (I) frame or slice are encoded using spatial prediction with respect to neighboring macroblocks. Macroblocks in an inter-coded (P or B) frame or slice may use spatial prediction with respect to neighboring macroblocks in the same frame or slice or temporal prediction with respect to other reference frames.

After video data has been encoded, the video data may be packetized for transmission or storage. The video data may be assembled into a video file conforming to any of a variety of standards, such as the International Organization for Standardization (ISO) base media file format and extensions thereof, such as AVC.

### SUMMARY

In general, this disclosure describes techniques for exchanging media data via a computer-based network, such as a network conforming to 3GPP standards, e.g., 5G. When transmitting media data via a network, the media data may include sets of data to be presented at the same time, e.g., a frame of video data, audio data, timed text data (e.g., closed caption data), or the like. The set of data that is to be presented at the same time may be referred to as a protocol data unit (PDU) set. Because the data of the PDU set is to be presented at the same time, it is important that packets of the PDU set arrive at or be available at a destination (e.g., a user equipment (UE) device) at substantially the same time. Thus, a PDU set size (PSSize) value may be added to one or more packets of the PDU set to indicate the size of the data for the PDU set.

However, IP fragmentation may occur during network transmission, which may change the number of PDUs included in the PDU set. This may occur because different devices in the network between the source device and the destination device (e.g., the UE) have different maximum transmission unit (MTU) sizes or different IP address types (e.g., IPv4 vs. IPv6). Thus, per techniques of this disclosure, the UE device may determine the IP address type and the MTU size for the source device (which may be another UE device) and signal the IP address type and the MTU size for the source device to a gateway device, e.g., a device executing a user plane function (UPF). The gateway device may then use the IP address type and the MTU size to recalculate the PSSize value, if necessary.

In one example, a method of exchanging media data via a network includes: receiving, by a user equipment (UE) device, data from a second network device via a radio access network (RAN), the data from the second network device including a local Internet protocol (IP) address type for the second network device and a maximum transmission unit (MTU) size for the second network device; establishing, by the UE device, a media communication session with the second network device; sending, by the UE device, data representing the local IP address type and the MTU size for the second network device to a gateway device of the RAN; and receiving, by the UE device, packets of a protocol data unit (PDU) set of the media communication session originating from the second network device via the RAN.

In another example, a user equipment (UE) device for exchanging media data via a network includes: a memory configured to store media data; and a processing system comprising one or more processors implemented in circuitry, the processing system being configured to: receive data from a second network device via a radio access network (RAN), the data from the second network device including a local Internet protocol (IP) address type for the second network device and a maximum transmission unit (MTU) size for the second network device; establish a media communication session with the second network device; send data representing the local IP address type and the MTU size for the second network device to a gateway device of the RAN; and receive packets of a protocol data unit (PDU) set of the media communication session originating from the second network device via the RAN.

In another example, a method of exchanging media data via a network includes: receiving, by a gateway device and from a user equipment (UE) device, data representing a local Internet protocol (IP) address type and a maximum transmission unit (MTU) size for a second network device, wherein the gateway device is within a radio access network (RAN) to which the UE device is communicatively coupled; receiving, by the gateway device, a first data packet of a first protocol data unit (PDU); determining, by the gateway device, that a source IP address of the first data packet matches an IP address of the second network device; adjusting, by the gateway device, a PDU set size value (PSSize) value based on the local IP address type, the MTU size, and a number of PDUs for the first PDU; encapsulating, by the gateway device, the first data packet in a GPRS tunneling protocol (GTP-U) packet; adding, by the gateway device, the adjusted PSSize value to a header of the GTP-U packet; and sending, by the gateway device, the GTP-U packet to the UE device via the RAN.

In another example, a gateway device of a radio access network (RAN) includes: a memory configured to store network packets; and a processing system implemented in circuitry, the processing system being configured to: receive, from a user equipment (UE) device communicatively coupled to the RAN, data representing a local Internet protocol (IP) address type and a maximum transmission unit (MTU) size for a second network device; receive a first data packet of a first protocol data unit (PDU); determine that a source IP address of the first data packet matches an IP address of the second network device; adjust a PDU set size value (PSSize) value based on the local IP address type, the MTU size, and a number of PDUs for the first PDU; encapsulate the first data packet in a GPRS tunneling protocol (GTP-U) packet; add the adjusted PSSize value to a header of the GTP-U packet; and send the GTP-U packet to the UE device via the RAN.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a block diagram illustrating an example system that implements techniques for streaming media data over a network.

FIG. 2 is a block diagram illustrating elements of an example video file.

FIG. 3 is a block diagram illustrating an example set of devices that may participate in a media communication session according to techniques of this disclosure.

FIG. 4 is a flow diagram illustrating an example method of sending a local/private address type according to techniques of this disclosure.

FIG. 5 is a flow diagram illustrating another example method of sending a local/private address type according to techniques of this disclosure.

### DETAILED DESCRIPTION

In general, this disclosure describes techniques for exchanging media data via a network. The network may be a 5G network, a 6G network, or other radio access network (RAN). A protocol data unit (PDU) set represents one or more PDUs each carrying a payload of a unit of information generated at the application level. Thus, for example, a PDU may include a frame of video data, a slice of a frame of video data, audio data, computer graphics data, or other media data for an extended reality (XR) service. 3GPP TS23.501 v.18.1.0 includes this definition of a PDU set.

When two (or more) devices are engaged in an XR session, one device may send a PDU set size to another device, where the PDU set size may represent the total size of All PDUs of the PDU set to which a particular PDU belongs, including RTP/UDP/IP header encapsulation overhead of the corresponding PDUs. An RTP (real-time transport protocol) sender may compute the PDU set size value (PSSize) and include the PSSize value in an RTP header extension of an RTP packet sent to the RTP receiver. However, the IP address version (e.g., IPv4 or IPv6) used by the RTP sender locally to generate the IP packets encapsulating the RTP (and/or, in some cases, UDP (user datagram protocol)) packets may be different from the IP version sent to a gateway device (e.g., a device executing a user plane function (UPF)), due to network tunneling (e.g., IPv4-v6 tunneling, carrier grade network address translation (CGNAT), or network address translation-protocol translation (NAT-PT)).

Therefore, absent the techniques of this disclosure, the PSSize value provided by the RTP sender may be inaccurate. That is, absent these techniques, the PSSize may not accurately reflect the size of the PDU set, due to inclusion or exclusion of the local and/or global network address. In RFC 4566 (which specifies the session description protocol (SDP) standard), the address type and the address defined in the “c=” line and the “o=” line are for the global or public address, not the local or private address.

This disclosure describes techniques for exchanging local address information related to a media communication session, e.g., between devices involved in the media communication session or with other intermediate devices, which may use the local address information, e.g., to recalculate the PDU set size value or interpret the PDU set size value.

U.S. Provisional Application No. 63/580,250, filed Sep. 1, 2023, entitled “EXCHANGING LOCAL ADDRESS INFORMATION FOR A MEDIA COMMUNICATION SESSION,” described using an SDP attribute to convey a local/private address type for an RTP packet source. That is, the '250 provisional application describes a control plane solution that can help with the processing of PDU set information at the gateway device and can be used for other purposes.

This disclosure describes an alternative, data plane solution. This disclosure describes techniques for carrying the local/private address type along with the PDU set data. This may eliminate the control plane signaling overhead and may be more robust in certain scenarios (e.g., when the IP address type changes due to mobility/movement of a mobile device between cells).

For the gateway device to be able to adjust the PDU set size (PSSize), the gateway device needs to determine the number PDUs in a PDU set. However, IP fragmentation may occur in the network, which may change the number of PDUs processed by the gateway device, because IP reassembly is typically done at the destination rather than at intermediate routers, to reduce the load in the intermediate routers.

This disclosure also describes techniques for signaling the original MTU size. This can be done, in some examples, via an RTP header extension or via SDP signaling.

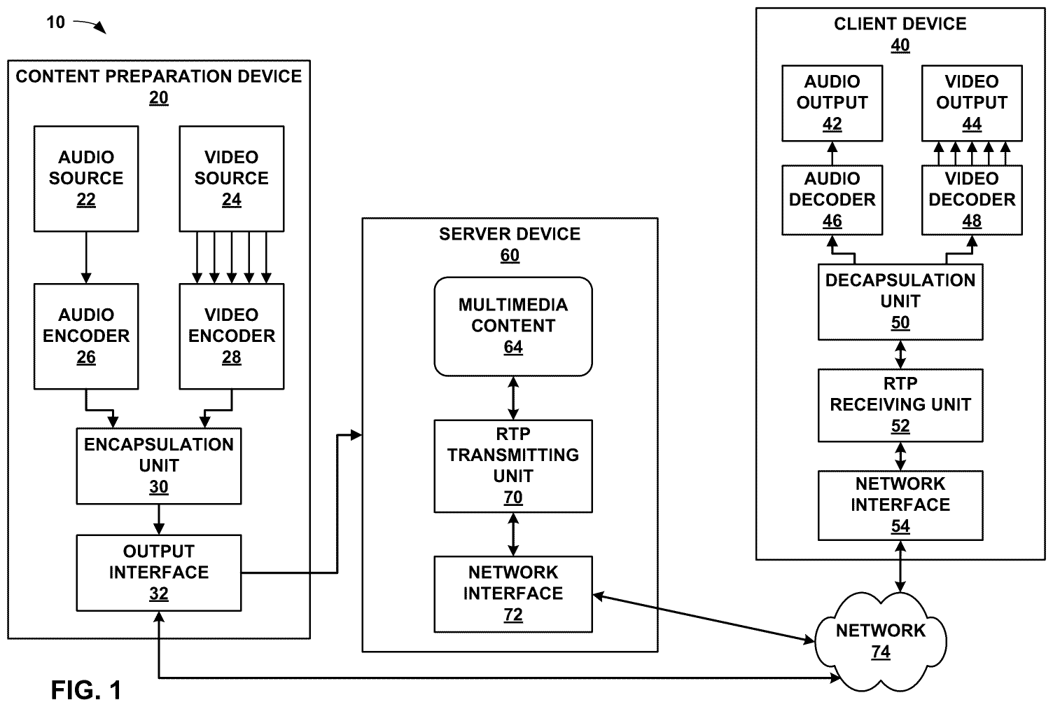

FIG. 1 is a block diagram illustrating an example system 10 that implements techniques for streaming media data over a network. In this example, system 10 includes content preparation device 20, server device 60, and client device 40. Client device 40 and server device 60 are communicatively coupled by network 74, which may comprise the Internet. In some examples, content preparation device 20 and server device 60 may also be coupled by network 74 or another network, or may be directly communicatively coupled. In some examples, content preparation device 20 and server device 60 may comprise the same device.

Content preparation device 20, in the example of FIG. 1, comprises audio source 22 and video source 24. Audio source 22 may comprise, for example, a microphone that produces electrical signals representative of captured audio data to be encoded by audio encoder 26. Alternatively, audio source 22 may comprise a storage medium storing previously recorded audio data, an audio data generator such as a computerized synthesizer, or any other source of audio data. Video source 24 may comprise a video camera that produces video data to be encoded by video encoder 28, a storage medium encoded with previously recorded video data, a video data generation unit such as a computer graphics source, or any other source of video data. Content preparation device 20 is not necessarily communicatively coupled to server device 60 in all examples, but may store multimedia content to a separate medium that is read by server device 60.

Raw audio and video data may comprise analog or digital data. Analog data may be digitized before being encoded by audio encoder 26 and/or video encoder 28. Audio source 22 may obtain audio data from a speaking participant while the speaking participant is speaking, and video source 24 may simultaneously obtain video data of the speaking participant. In other examples, audio source 22 may comprise a computer-readable storage medium comprising stored audio data, and video source 24 may comprise a computer-readable storage medium comprising stored video data. In this manner, the techniques described in this disclosure may be applied to live, streaming, real-time audio and video data or to archived, pre-recorded audio and video data.

Audio frames that correspond to video frames are generally audio frames containing audio data that was captured (or generated) by audio source 22 contemporaneously with video data captured (or generated) by video source 24 that is contained within the video frames. For example, while a speaking participant generally produces audio data by speaking, audio source 22 captures the audio data, and video source 24 captures video data of the speaking participant at the same time, that is, while audio source 22 is capturing the audio data. Hence, an audio frame may temporally correspond to one or more particular video frames. Accordingly, an audio frame corresponding to a video frame generally corresponds to a situation in which audio data and video data were captured at the same time and for which an audio frame and a video frame comprise, respectively, the audio data and the video data that was captured at the same time.

In some examples, audio encoder 26 may encode a timestamp in each encoded audio frame that represents a time at which the audio data for the encoded audio frame was recorded, and similarly, video encoder 28 may encode a timestamp in each encoded video frame that represents a time at which the video data for an encoded video frame was recorded. In such examples, an audio frame corresponding to a video frame may comprise an audio frame comprising a timestamp and a video frame comprising the same timestamp. Content preparation device 20 may include an internal clock from which audio encoder 26 and/or video encoder 28 may generate the timestamps, or that audio source 22 and video source 24 may use to associate audio and video data, respectively, with a timestamp.

In some examples, audio source 22 may send data to audio encoder 26 corresponding to a time at which audio data was recorded, and video source 24 may send data to video encoder 28 corresponding to a time at which video data was recorded. In some examples, audio encoder 26 may encode a sequence identifier in encoded audio data to indicate a relative temporal ordering of encoded audio data but without necessarily indicating an absolute time at which the audio data was recorded, and similarly, video encoder 28 may also use sequence identifiers to indicate a relative temporal ordering of encoded video data. Similarly, in some examples, a sequence identifier may be mapped or otherwise correlated with a timestamp.

Audio encoder 26 generally produces a stream of encoded audio data, while video encoder 28 produces a stream of encoded video data. Each individual stream of data (whether audio or video) may be referred to as an elementary stream. An elementary stream is a single, digitally coded (possibly compressed) component of a media presentation. For example, the coded video or audio part of the media presentation can be an elementary stream. An elementary stream may be converted into a packetized elementary stream (PES) before being encapsulated within a video file. Within the same media presentation, a stream ID may be used to distinguish the PES-packets belonging to one elementary stream from the other. The basic unit of data of an elementary stream is a packetized elementary stream (PES) packet. Thus, coded video data generally corresponds to elementary video streams. Similarly, audio data corresponds to one or more respective elementary streams.

In the example of FIG. 1, encapsulation unit 30 of content preparation device 20 receives elementary streams comprising coded video data from video encoder 28 and elementary streams comprising coded audio data from audio encoder 26. In some examples, video encoder 28 and audio encoder 26 may each include packetizers for forming PES packets from encoded data. In other examples, video encoder 28 and audio encoder 26 may each interface with respective packetizers for forming PES packets from encoded data. In still other examples, encapsulation unit 30 may include packetizers for forming PES packets from encoded audio and video data.

Video encoder 28 may encode video data of multimedia content in a variety of ways, to produce different representations of the multimedia content at various bitrates and with various characteristics, such as pixel resolutions, frame rates, conformance to various coding standards, conformance to various profiles and/or levels of profiles for various coding standards, representations having one or multiple views (e.g., for two-dimensional or three-dimensional playback), or other such characteristics. A representation, as used in this disclosure, may comprise one of audio data, video data, text data (e.g., for closed captions), or other such data. The representation may include an elementary stream, such as an audio elementary stream or a video elementary stream. Each PES packet may include a stream_id that identifies the elementary stream to which the PES packet belongs. Encapsulation unit 30 is responsible for assembling elementary streams into streamable media data.

Encapsulation unit 30 receives PES packets for elementary streams of a media presentation from audio encoder 26 and video encoder 28 and forms corresponding network abstraction layer (NAL) units from the PES packets. Coded video segments may be organized into NAL units, which provide a “network-friendly” video representation addressing applications such as video telephony, storage, broadcast, or streaming. NAL units can be categorized to Video Coding Layer (VCL) NAL units and non-VCL NAL units. VCL units may contain the core compression engine and may include block, macroblock, and/or slice level data. Other NAL units may be non-VCL NAL units. In some examples, a coded picture in one time instance, normally presented as a primary coded picture, may be contained in an access unit, which may include one or more NAL units.

Non-VCL NAL units may include parameter set NAL units and SEI NAL units, among others. Parameter sets may contain sequence-level header information (in sequence parameter sets (SPS)) and the infrequently changing picture-level header information (in picture parameter sets (PPS)). With parameter sets (e.g., PPS and SPS), infrequently changing information need not to be repeated for each sequence or picture; hence, coding efficiency may be improved. Furthermore, the use of parameter sets may enable out-of-band transmission of the important header information, avoiding the need for redundant transmissions for error resilience. In out-of-band transmission examples, parameter set NAL units may be transmitted on a different channel than other NAL units, such as SEI NAL units.

Supplemental Enhancement Information (SEI) may contain information that is not necessary for decoding the coded pictures samples from VCL NAL units, but may assist in processes related to decoding, display, error resilience, and other purposes. SEI messages may be contained in non-VCL NAL units. SEI messages are the normative part of some standard specifications, and thus are not always mandatory for standard compliant decoder implementation. SEI messages may be sequence level SEI messages or picture level SEI messages. Some sequence level information may be contained in SEI messages, such as scalability information SEI messages in the example of SVC and view scalability information SEI messages in MVC. These example SEI messages may convey information on, e.g., extraction of operation points and characteristics of the operation points.

Server device 60 includes Real-time Transport Protocol (RTP) transmitting unit 70 and network interface 72. In some examples, server device 60 may include a plurality of network interfaces. Furthermore, any or all of the features of server device 60 may be implemented on other devices of a content delivery network, such as routers, bridges, proxy devices, switches, or other devices. In some examples, intermediate devices of a content delivery network may cache data of multimedia content 64 and include components that conform substantially to those of server device 60. In general, network interface 72 is configured to send and receive data via network 74.

RTP transmitting unit 70 is configured to deliver media data to client device 40 via network 74 according to RTP, which is standardized in Request for Comment (RFC) 3550 by the Internet Engineering Task Force (IETF). RTP transmitting unit 70 may also implement protocols related to RTP, such as RTP Control Protocol (RTCP), Real-time Streaming Protocol (RTSP), Session Initiation Protocol (SIP), and/or Session Description Protocol (SDP). RTP transmitting unit 70 may send media data via network interface 72, which may implement Uniform Datagram Protocol (UDP) and/or Internet protocol (IP). Thus, in some examples, server device 60 may send media data via RTP and RTSP over UDP using network 74.

RTP transmitting unit 70 may receive an RTSP describe request from, e.g., client device 40. The RTSP describe request may include data indicating what types of data are supported by client device 40. RTP transmitting unit 70 may respond to client device 40 with data indicating media streams, such as media content 64, that can be sent to client device 40, along with a corresponding network location identifier, such as a uniform resource locator (URL) or uniform resource name (URN).

RTP transmitting unit 70 may then receive an RTSP setup request from client device 40. The RTSP setup request may generally indicate how a media stream is to be transported. The RTSP setup request may contain the network location identifier for the requested media data (e.g., media content 64) and a transport specifier, such as local ports for receiving RTP data and control data (e.g., RTCP data) on client device 40. RTP transmitting unit 70 may reply to the RTSP setup request with a confirmation and data representing ports of server device 60 by which the RTP data and control data will be sent. RTP transmitting unit 70 may then receive an RTSP play request, to cause the media stream to be “played,” i.e., sent to client device 40 via network 74. RTP transmitting unit 70 may also receive an RTSP teardown request to end the streaming session, in response to which, RTP transmitting unit 70 may stop sending media data to client device 40 for the corresponding session.

RTP receiving unit 52, likewise, may initiate a media stream by initially sending an RTSP describe request to server device 60. The RTSP describe request may indicate types of data supported by client device 40. RTP receiving unit 52 may then receive a reply from server device 60 specifying available media streams, such as media content 64, that can be sent to client device 40, along with a corresponding network location identifier, such as a uniform resource locator (URL) or uniform resource name (URN).

RTP receiving unit 52 may then generate an RTSP setup request and send the RTSP setup request to server device 60. As noted above, the RTSP setup request may contain the network location identifier for the requested media data (e.g., media content 64) and a transport specifier, such as local ports for receiving RTP data and control data (e.g., RTCP data) on client device 40. In response, RTP receiving unit 52 may receive a confirmation from server device 60, including ports of server device 60 that server device 60 will use to send media data and control data.

After establishing a media streaming session between server device 60 and client device 40, RTP transmitting unit 70 of server device 60 may send media data (e.g., packets of media data) to client device 40 according to the media streaming session. Server device 60 and client device 40 may exchange control data (e.g., RTCP data) indicating, for example, reception statistics by client device 40, such that server device 60 can perform congestion control or otherwise diagnose and address transmission faults.

RTP transmitting unit 70 may, according to the techniques of this disclosure, convey additional PDU set information via an RTP header extension. For example, RTP transmitting unit 70 may include at least one of a local address type, an MTU size at the source (e.g., server device 60), and/or the number of PDUs in an RTP header extension. The RTP header extension may be an RTP header extension for PDU set marking that includes any or all of the following information: an indication of an end PDU of the PDU set, an end of data burst indication, a PDU set importance indication, a PDU set sequence number indication, a PDU sequence number within a PDU set indication, and/or a PDU set size (PSSize).

The local address type may be a type of IP address based on which the PSSize is calculated. The local address type may be, for example, IPv4, IPv6, Ethernet, or unstructured, in some examples. The local address type may occupy 1 or 2 bits, e.g., in the RTP header extension.

The MTU size at the source may be the MTU size of the network at the source of the PDU set. The gateway device may use the MTU size in the incoming link where the PDU set is received. The gateway device may compare the indicated MTU size to the MTU size at the source and adjust the number of PDUs accordingly. The number of PDUs may be the number of PDUs in the PDU set.

Additionally or alternatively, an SDP attribute may be used to indicate the MTU size. The SDP attribute may have the following format: “a=mtu: <mtu-size>,” where mtu-size is the size of the MTU at the sender of the SDP message. The unit of the mtu-size may be in bytes or a multiple of bytes, e.g., x-bytes, where x may be, for example, 4, 8, 10, or other multiple values. The MTU size attribute may be included in the SDP offer message or in the SDP answer message.

Additionally or alternatively, an application function (AF) (not shown in FIG. 1) may be configured to process relevant session data. A UE, e.g., client device 40, may extract at least one of the local IP address type indicator and/or the MTU size indicator from the session setup message (e.g., the SDP offer/answer messages). The UE may send the extracted information to the AF, along with an identifier of the other endpoint (e.g., an application server (AS)) of the session (e.g., server device 60 or content preparation device 20). The identifier may include one or more of the public IP address of the other endpoint, the port number of the other endpoint, the IP 5-tuple (e.g., {source IP address, destination IP address, source port, destination port, protocol}), the service data flow identifier (ID), and/or other data associated with the session. The AF may forward the extracted information to the gateway device via a policy and charging function (PCF) and/or a session management function (SMF).

The gateway device may then extract the information, identify the downlink data packets (e.g., RTP packets) by the identifier, and extract the PSSize and, optionally, the number of PDUs if present. The gateway device may further adjust the PSSize if needed, and add data representing the resulting PSSize in a GPRS tunneling protocol (GTP) GTP-U packet header of a GTP-U packet that encapsulates the downlink data packet. GTP-U is an IP-based protocol for carrying user data within a GRPS core network between a radio access network (RAN) and a core network. GTP-U may transport packets in any of IPV4, IPv6, point-to-point protocol (PPP), or other such tunneled transport formats.

Network interface 54 may receive and provide media of a selected media presentation to RTP receiving unit 52, which may in turn provide the media data to decapsulation unit 50. Decapsulation unit 50 may decapsulate elements of a video file into constituent PES streams, depacketize the PES streams to retrieve encoded data, and send the encoded data to either audio decoder 46 or video decoder 48, depending on whether the encoded data is part of an audio or video stream, e.g., as indicated by PES packet headers of the stream. Audio decoder 46 decodes encoded audio data and sends the decoded audio data to audio output 42, while video decoder 48 decodes encoded video data and sends the decoded video data, which may include a plurality of views of a stream, to video output 44.

Video encoder 28, video decoder 48, audio encoder 26, audio decoder 46, encapsulation unit 30, RTP receiving unit 52, and decapsulation unit 50 each may be implemented as any of a variety of suitable processing circuitry, as applicable, such as one or more microprocessors, digital signal processors (DSPs), application specific integrated circuits (ASICs), field programmable gate arrays (FPGAs), discrete logic circuitry, software, hardware, firmware or any combinations thereof. Each of video encoder 28 and video decoder 48 may be included in one or more encoders or decoders, either of which may be integrated as part of a combined video encoder/decoder (CODEC). Likewise, each of audio encoder 26 and audio decoder 46 may be included in one or more encoders or decoders, either of which may be integrated as part of a combined CODEC. An apparatus including video encoder 28, video decoder 48, audio encoder 26, audio decoder 46, encapsulation unit 30, RTP receiving unit 52, and/or decapsulation unit 50 may comprise an integrated circuit, a microprocessor, and/or a wireless communication device, such as a cellular telephone.

Client device 40, server device 60, and/or content preparation device 20 may be configured to operate in accordance with the techniques of this disclosure. For purposes of example, this disclosure describes these techniques with respect to client device 40 and server device 60. However, it should be understood that content preparation device 20 may be configured to perform these techniques, instead of (or in addition to) server device 60.

Encapsulation unit 30 may form NAL units comprising a header that identifies a program to which the NAL unit belongs, as well as a payload, e.g., audio data, video data, or data that describes the transport or program stream to which the NAL unit corresponds. For example, in H.264/AVC, a NAL unit includes a 1-byte header and a payload of varying size. A NAL unit including video data in its payload may comprise various granularity levels of video data. For example, a NAL unit may comprise a block of video data, a plurality of blocks, a slice of video data, or an entire picture of video data. Encapsulation unit 30 may receive encoded video data from video encoder 28 in the form of PES packets of elementary streams. Encapsulation unit 30 may associate each elementary stream with a corresponding program.

Encapsulation unit 30 may also assemble access units from a plurality of NAL units. In general, an access unit may comprise one or more NAL units for representing a frame of video data, as well as audio data corresponding to the frame when such audio data is available. An access unit generally includes all NAL units for one output time instance, e.g., all audio and video data for one time instance. For example, if each view has a frame rate of 20 frames per second (fps), then each time instance may correspond to a time interval of 0.05 seconds. During this time interval, the specific frames for all views of the same access unit (the same time instance) may be rendered simultaneously. In one example, an access unit may comprise a coded picture in one time instance, which may be presented as a primary coded picture.

Accordingly, an access unit may comprise all audio and video frames of a common temporal instance, e.g., all views corresponding to time X. This disclosure also refers to an encoded picture of a particular view as a “view component.” That is, a view component may comprise an encoded picture (or frame) for a particular view at a particular time. Accordingly, an access unit may be defined as comprising all view components of a common temporal instance. The decoding order of access units need not necessarily be the same as the output or display order.

After encapsulation unit 30 has assembled NAL units and/or access units into a video file based on received data, encapsulation unit 30 passes the video file to output interface 32 for output. In some examples, encapsulation unit 30 may store the video file locally or send the video file to a remote server via output interface 32, rather than sending the video file directly to client device 40. Output interface 32 may comprise, for example, a transmitter, a transceiver, a device for writing data to a computer-readable medium such as, for example, an optical drive, a magnetic media drive (e.g., floppy drive), a universal serial bus (USB) port, a network interface, or other output interface. Output interface 32 outputs the video file to a computer-readable medium, such as, for example, a transmission signal, a magnetic medium, an optical medium, a memory, a flash drive, or other computer-readable medium.

Network interface 54 may receive a NAL unit or access unit via network 74 and provide the NAL unit or access unit to decapsulation unit 50, via RTP receiving unit 52. Decapsulation unit 50 may decapsulate a elements of a video file into constituent PES streams, depacketize the PES streams to retrieve encoded data, and send the encoded data to either audio decoder 46 or video decoder 48, depending on whether the encoded data is part of an audio or video stream, e.g., as indicated by PES packet headers of the stream. Audio decoder 46 decodes encoded audio data and sends the decoded audio data to audio output 42, while video decoder 48 decodes encoded video data and sends the decoded video data, which may include a plurality of views of a stream, to video output 44.

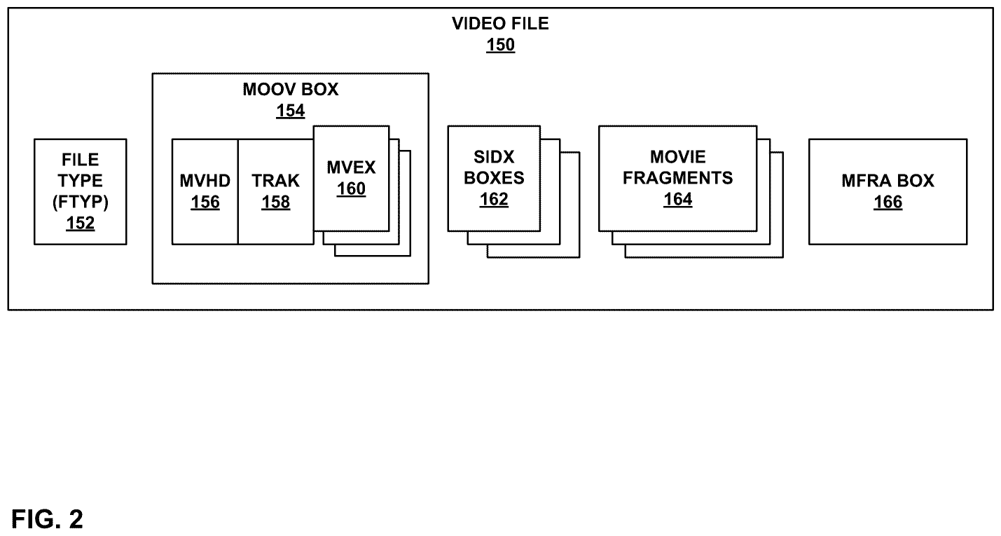

FIG. 2 is a block diagram illustrating elements of an example video file 150. As described above, video files in accordance with the ISO base media file format and extensions thereof store data in a series of objects, referred to as “boxes.” In the example of FIG. 2, video file 150 includes file type (FTYP) box 152, movie (MOOV) box 154, segment index (sidx) boxes 162, movie fragment (MOOF) boxes 164, and movie fragment random access (MFRA) box 166. Although FIG. 2 represents an example of a video file, it should be understood that other media files may include other types of media data (e.g., audio data, timed text data, or the like) that is structured similarly to the data of video file 150, in accordance with the ISO base media file format and its extensions.

File type (FTYP) box 152 generally describes a file type for video file 150. File type box 152 may include data that identifies a specification that describes a best use for video file 150. File type box 152 may alternatively be placed before MOOV box 154, movie fragment boxes 164, and/or MFRA box 166.

MOOV box 154, in the example of FIG. 2, includes movie header (MVHD) box 156, track (TRAK) box 158, and one or more movie extends (MVEX) boxes 160. In general, MVHD box 156 may describe general characteristics of video file 150. For example, MVHD box 156 may include data that describes when video file 150 was originally created, when video file 150 was last modified, a timescale for video file 150, a duration of playback for video file 150, or other data that generally describes video file 150.

TRAK box 158 may include data for a track of video file 150. TRAK box 158 may include a track header (TKHD) box that describes characteristics of the track corresponding to TRAK box 158. In some examples, TRAK box 158 may include coded video pictures, while in other examples, the coded video pictures of the track may be included in movie fragments 164, which may be referenced by data of TRAK box 158 and/or sidx boxes 162.

In some examples, video file 150 may include more than one track. Accordingly, MOOV box 154 may include a number of TRAK boxes equal to the number of tracks in video file 150. TRAK box 158 may describe characteristics of a corresponding track of video file 150. For example, TRAK box 158 may describe temporal and/or spatial information for the corresponding track. A TRAK box similar to TRAK box 158 of MOOV box 154 may describe characteristics of a parameter set track, when encapsulation unit 30 (FIG. 1) includes a parameter set track in a video file, such as video file 150. Encapsulation unit 30 may signal the presence of sequence level SEI messages in the parameter set track within the TRAK box describing the parameter set track.

MVEX boxes 160 may describe characteristics of corresponding movie fragments 164, e.g., to signal that video file 150 includes movie fragments 164, in addition to video data included within MOOV box 154, if any. In the context of streaming video data, coded video pictures may be included in movie fragments 164 rather than in MOOV box 154. Accordingly, all coded video samples may be included in movie fragments 164, rather than in MOOV box 154.

MOOV box 154 may include a number of MVEX boxes 160 equal to the number of movie fragments 164 in video file 150. Each of MVEX boxes 160 may describe characteristics of a corresponding one of movie fragments 164. For example, each MVEX box may include a movie extends header box (MEHD) box that describes a temporal duration for the corresponding one of movie fragments 164.

As noted above, encapsulation unit 30 may store a sequence data set in a video sample that does not include actual coded video data. A video sample may generally correspond to an access unit, which is a representation of a coded picture at a specific time instance. In the context of AVC, the coded picture include one or more VCL NAL units, which contain the information to construct all the pixels of the access unit and other associated non-VCL NAL units, such as SEI messages. Accordingly, encapsulation unit 30 may include a sequence data set, which may include sequence level SEI messages, in one of movie fragments 164. Encapsulation unit 30 may further signal the presence of a sequence data set and/or sequence level SEI messages as being present in one of movie fragments 164 within the one of MVEX boxes 160 corresponding to the one of movie fragments 164.

SIDX boxes 162 are optional elements of video file 150. That is, video files conforming to the 3GPP file format, or other such file formats, do not necessarily include SIDX boxes 162. In accordance with the example of the 3GPP file format, a SIDX box may be used to identify a sub-segment of a segment (e.g., a segment contained within video file 150). The 3GPP file format defines a sub-segment as “a self-contained set of one or more consecutive movie fragment boxes with corresponding Media Data box(es) and a Media Data Box containing data referenced by a Movie Fragment Box must follow that Movie Fragment box and precede the next Movie Fragment box containing information about the same track.” The 3GPP file format also indicates that a SIDX box “contains a sequence of references to subsegments of the (sub) segment documented by the box. The referenced subsegments are contiguous in presentation time. Similarly, the bytes referred to by a Segment Index box are always contiguous within the segment. The referenced size gives the count of the number of bytes in the material referenced.”

SIDX boxes 162 generally provide information representative of one or more sub-segments of a segment included in video file 150. For instance, such information may include playback times at which sub-segments begin and/or end, byte offsets for the sub-segments, whether the sub-segments include (e.g., start with) a stream access point (SAP), a type for the SAP (e.g., whether the SAP is an instantaneous decoder refresh (IDR) picture, a clean random access (CRA) picture, a broken link access (BLA) picture, or the like), a position of the SAP (in terms of playback time and/or byte offset) in the sub-segment, and the like.

Movie fragments 164 may include one or more coded video pictures. In some examples, movie fragments 164 may include one or more groups of pictures (GOPs), each of which may include a number of coded video pictures, e.g., frames or pictures. In addition, as described above, movie fragments 164 may include sequence data sets in some examples. Each of movie fragments 164 may include a movie fragment header box (MFHD, not shown in FIG. 2). The MFHD box may describe characteristics of the corresponding movie fragment, such as a sequence number for the movie fragment. Movie fragments 164 may be included in order of sequence number in video file 150.

MFRA box 166 may describe random access points within movie fragments 164 of video file 150. This may assist with performing trick modes, such as performing seeks to particular temporal locations (i.e., playback times) within a segment encapsulated by video file 150. MFRA box 166 is generally optional and need not be included in video files, in some examples. Likewise, a client device, such as client device 40, does not necessarily need to reference MFRA box 166 to correctly decode and display video data of video file 150. MFRA box 166 may include a number of track fragment random access (TFRA) boxes (not shown) equal to the number of tracks of video file 150, or in some examples, equal to the number of media tracks (e.g., non-hint tracks) of video file 150.

In some examples, movie fragments 164 may include one or more stream access points (SAPs), such as IDR pictures. Likewise, MFRA box 166 may provide indications of locations within video file 150 of the SAPs. Accordingly, a temporal sub-sequence of video file 150 may be formed from SAPs of video file 150. The temporal sub-sequence may also include other pictures, such as P-frames and/or B-frames that depend from SAPs. Frames and/or slices of the temporal sub-sequence may be arranged within the segments such that frames/slices of the temporal sub-sequence that depend on other frames/slices of the sub-sequence can be properly decoded. For example, in the hierarchical arrangement of data, data used for prediction for other data may also be included in the temporal sub-sequence.

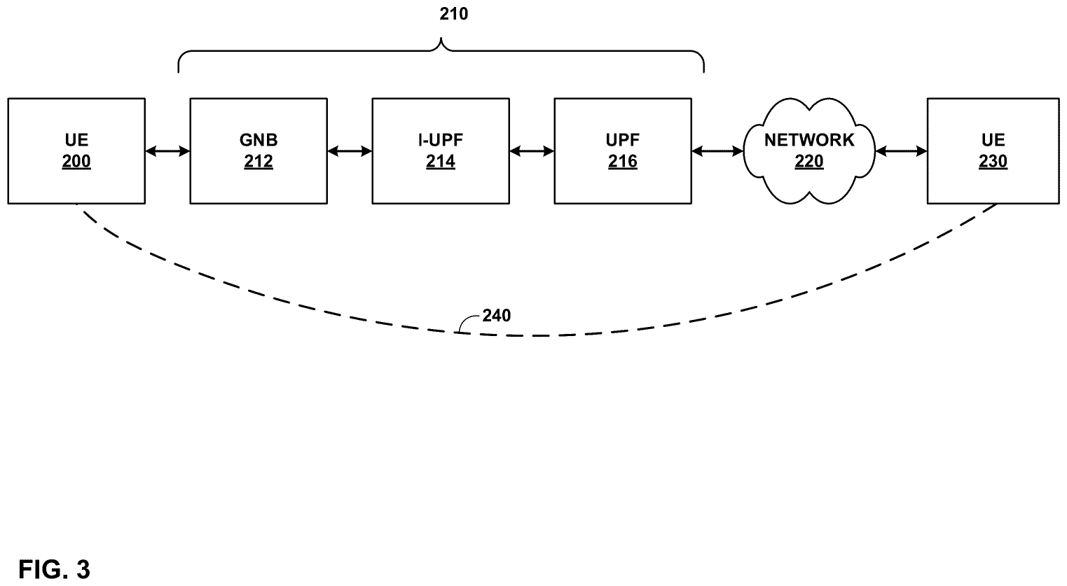

FIG. 3 is a block diagram illustrating an example set of devices that may participate in a media communication session according to techniques of this disclosure. The example of FIG. 3 depicts user equipment (UE) device 200, gNodeB (gNB) device 212, intermediate user plane function (I-UPF) device 214, UPF device 216 (which may also be referred to as a “gateway device”), network 220, and UE device 230. UE device 200 may correspond to client device 40 of FIG. 1, while UE device 230 may correspond to content preparation device 20 and/or server device 60 of FIG. 1.

In this example, gNB device 212, I-UPF device 214, and UPF device 216 form part of radio access network (RAN) 210. In this example, UE device 200 represents an endpoint of RAN 210, gNB device 212 and I-UPF device 214 are included in an access network of RAN 210, and UPF device 216 is included in a core network of RAN 210. Network 220 may correspond to a data network, such as the Internet. UE device 230 may be communicatively coupled to a separate RAN (not shown) or be communicatively coupled to network 220 via other access technologies, such as Wi-Fi, Ethernet, or the like.

In this example, UE device 200 and UE device 230 establish media communication session 240 by which UE device 200 and UE device 230 may exchange media data, such as audio data, image data, video data, text data, extended reality (XR) data such as augmented reality (AR), mixed reality (MR), or virtual reality (VR) data, or the like.

As part of establishing media communication session 240, UE device 230 may send data representing an IP address type for UE device 230 and a maximum transmission unit (MTU) size for UE device 230 to UE device 200. For example, UE device 230 may send a real-time transport protocol (RTP) packet including an RTP header extension including data representing the IP address type and the MTU size. Additionally or alternatively, UE device 230 may send a session description protocol (SDP) message (e.g., an SDP offer or an SDP answer) specifying the IP address type and the MTU size.

Per techniques of this disclosure, UE device 200 may send data representing the local IP address type for UE device 230 and the MTU size for UE device 230 to UPF 216. For example, UE device 200 may send the data directly to UPF 216, or UE device 200 may send the data to an application function (AF) device to cause the AF device to forward the IP address type and the MTU size to UPF 216. UPF 216 may use the IP address type and the MTU size to recalculate PSSize values for packets of media communication session 2140 from UE device 230 destined for UE device 200.

Accordingly, when UPF 216 receives a packet of a PDU set from UE device 230, UPF 216 may initially determine that the packet of the PDU set originates from UE device 230 by comparing a source IP address to the IP address for UE device 230. UPF 216 may then use the local IP address type and MTU size for UE device 230 to recalculate a PSSize value for the PDU set. UPF 216 may forward packets of the PDU set to UE device 200 via I-UPF 214 and gNB device 212. For example, UPF 216 may encapsulate the packets with GTP-U packet headers to tunnel the packets to gNB device 212. UPF 216 may advertise the recalculated PSSize value for the packets in a GTP-U header. gNB device 212 may use the recalculated PSSize value advertised in the GTP-U header to, e.g., allocate resources for delivering the packets of the PDU set to UE device 200.

In this manner, UE device 200 represents an example of a user equipment (UE) device for exchanging media data via a network, including: a memory configured to store media data; and a processing system comprising one or more processors implemented in circuitry, the processing system being configured to: receive data from a second network device via a radio access network (RAN), the data from the second network device including a local Internet protocol (IP) address type for the second network device and a maximum transmission unit (MTU) size for the second network device; establish a media communication session with the second network device; send data representing the local IP address type and the MTU size for the second network device to a gateway device of the RAN; and receive packets of a protocol data unit (PDU) set of the media communication session originating from the second network device via the RAN.

Likewise, UPF device 216 represents an example of a gateway device of a radio access network (RAN), the device comprising: a memory configured to store network packets; and a processing system implemented in circuitry, the processing system being configured to: receive, from a user equipment (UE) device communicatively coupled to the RAN, data representing a local Internet protocol (IP) address type and a maximum transmission unit (MTU) size for a second network device; receive a first data packet of a first protocol data unit (PDU); determine that a source IP address of the first data packet matches an IP address of the second network device; adjust a PDU set size value (PSSize) value based on the local IP address type, the MTU size, and a number of PDUs for the first PDU; encapsulate the first data packet in a GPRS tunneling protocol (GTP-U) packet; add the adjusted PSSize value to a header of the GTP-U packet; and send the GTP-U packet to the UE device via the RAN.

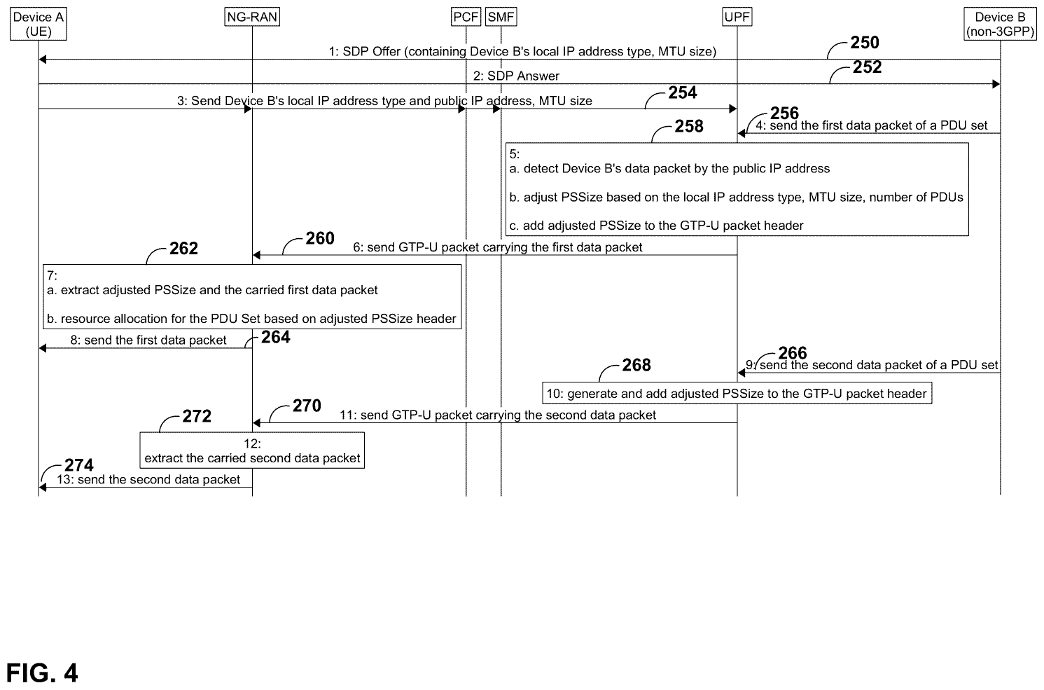

FIG. 4 is a flow diagram illustrating an example method of sending a local/private address type according to techniques of this disclosure. In this example, Device A represents a UE (e.g., client device 40 of FIG. 1 or UE device 200 of FIG. 3) and Device B represents a non-3GPP device, e.g., server device 60 or content preparation device 20 of FIG. 1 or UE device 230 of FIG. 3. The other devices of FIG. 4 represent 3GPP/5G devices executing various functions, e.g., an NG-RAN, a PCF, an SMF, and a UPF (e.g., a gateway device), as discussed above. The UPF of FIG. 4 may correspond to UPF 216 of FIG. 3. The NG-RAN device of FIG. 4 may correspond to gNB device 212 of FIG. 3.

In this example, initially, Device B sends an SDP offer containing the local IP address type and MTU size to Device A (250). Device A responds to Device B with an SDP answer (252). Device A sends the local IP address type, public IP address, and MTU size to the NG-RAN, the PCF, and/or the SMF (254). Device B then sends a first data packet of a PDU set to the UPF (256).

The UPF then performs a PSSize value adjustment per the techniques of this disclosure (258). In particular, the UPF detects that the first data packet originates from Device B using the public IP address of Device B as received from Device A. In response, the UPF adjusts the PSSize value based on the local IP address type of Device B, the MTU size, and the number of PDUs. The UPF may then add the adjusted PSSize to a GTP-U packet header of a GTP-U packet and send the GTP-U packet to the NG-RAN (260).

The NG-RAN (e.g., a base station, such as gNB, or other device of the RAN) may then use the PSSize value when delivering packets of the PDU set to Device A (262). For example, the NG-RAN may extract the adjusted PSSize and the first data packet received from the UPF. The NG-RAN may also allocate resources for the PDU set based on the adjusted PSSize header. The NG-RAN may then send the first data packet of the PDU set to Device A (264).

Device B may later send the second data packet of the PDU set to the UPF (266). The UPF may generate an updated PSSize value and add the adjusted PSSize value to a second GTP-U packet header (268). The UPF may then send the second GTP-U packet carrying the second data packet to the NG-RAN (270).

The NG-RAN may extract the second data packet from the second GTP-U packet (272) and send the second data packet to Device A (274).

In this manner, the method of FIG. 4 represents an example of a method of exchanging media data via a network, including: receiving, by a user equipment (UE) device, data from a second network device via a radio access network (RAN), the data from the second network device including a local Internet protocol (IP) address type for the second network device and a maximum transmission unit (MTU) size for the second network device; establishing, by the UE device, a media communication session with the second network device; sending, by the UE device, data representing the local IP address type and the MTU size for the second network device to a user plane function (UPF) device of the RAN; and receiving, by the UE device, packets of a protocol data unit (PDU) set of the media communication session originating from the second network device via the RAN.

The method of FIG. 4 also represents an example of a method of exchanging media data via a network, including: receiving, by a device executing a user plane function (UPF) and from a user equipment (UE) device, data representing a local Internet protocol (IP) address type and a maximum transmission unit (MTU) size for a second network device, wherein the device executing the UPF is within a radio access network (RAN) to which the UE device is communicatively coupled; receiving, by the device executing the UPF, a first data packet of a first protocol data unit (PDU); determining, by the device executing the UPF, that a source IP address of the first data packet matches an IP address of the second network device; adjusting, by the device executing the UPF, a PDU set size value (PSSize) value based on the local IP address type, the MTU size, and a number of PDUs for the first PDU; encapsulating, by the device executing the UPF, the first data packet in a GPRS tunneling protocol (GTP-U) packet; adding, by the device executing the UPF, the adjusted PSSize value to a header of the GTP-U packet; and sending, by the device executing the UPF, the GTP-U packet to the UE device via the RAN.

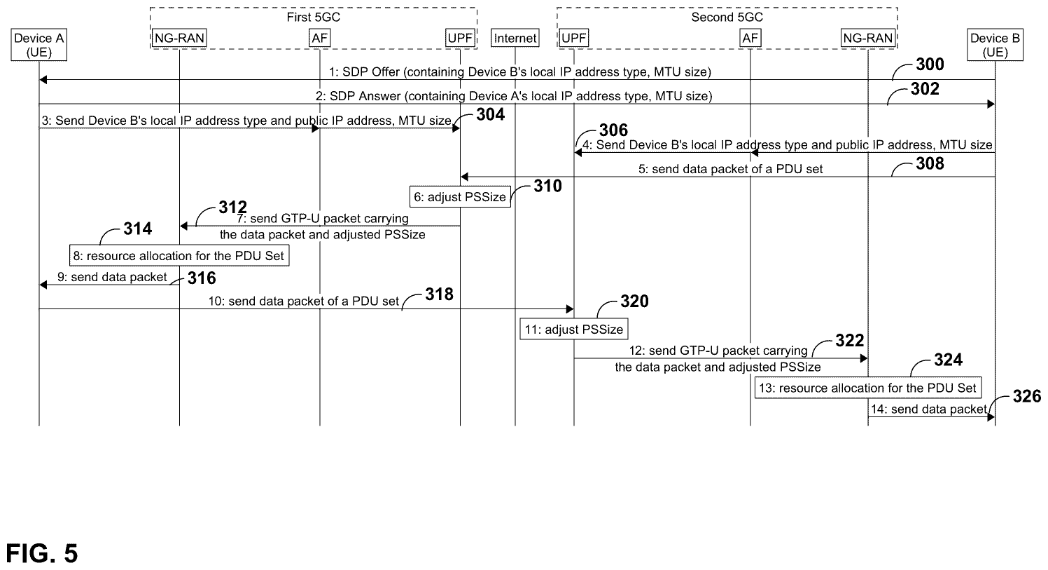

FIG. 5 is a flow diagram illustrating another example method of sending a local/private address type according to techniques of this disclosure. In this example, it is assumed that two 5G/3GPP capable devices, Device A and Device B, communicate with each other, but while connected to separate 5G core (5GC) networks. Device A may correspond to client device 40 of FIG. 1 or UE device 200 of FIG. 3, and Device B may correspond to content preparation device 20 and/or server device 60 of FIG. 1 or UE device 230 of FIG. 3. The first 5GC network (a first RAN) for Device A includes a first NG-RAN (e.g., gNB device 212 of FIG. 3), a first AF, and a first UPF (e.g., UPF 216 of FIG. 3), and the second 5GC network (a second RAN) for Device B includes a second NG-RAN, a second AF, and a second UPF.

In this example, Device B initially sends an SDP offer containing the local IP address type for Device B, along with an MTU size, to Device A (300). Device A responds with an SDP response including the local IP address type for Device A, along with an MTU size, to Device B (302).

Device A also sends the local IP address type and the MTU size for Device B to the AF and the UPF of the first 5GC (304), while Device B sends the local IP address type and the MTU size for Device A to the AF and the UPF of the second 5GC (306).

Device B in this example then sends a data packet of a PDU set (308), which is received by the UPF of the first 5GC. The UPF of the first 5GC adjusts the PSSize value (310) and sends a GTP-U packet carrying the data packet and the adjusted PSSize value to the NG-RAN of the first 5GC (312).

The NG-RAN of the first 5GC allocates resources for the PDU set (314) and sends the data packet to Device A (316).

Device A then sends a data packet of a separate PDU set (318), which is received by the UPF of the second 5GC. The UPF of the second 5GC adjusts the PSSize (320) and sends a second GTP-U packet carrying the data packet from Device A and the adjusted PSSize for the PDU set from the Device A to the NG-RAN of the second 5GC (322). The NG-RAN of the second 5GC allocates resources for the PDU set from Device A (324) and sends the data packet to Device B (326).

In this manner, the method of FIG. 5 represents an example of a method of exchanging media data via a network, including: receiving, by a user equipment (UE) device, data from a second network device via a radio access network (RAN), the data from the second network device including a local Internet protocol (IP) address type for the second network device and a maximum transmission unit (MTU) size for the second network device; establishing, by the UE device, a media communication session with the second network device; sending, by the UE device, data representing the local IP address type and the MTU size for the second network device to a user plane function (UPF) device of the RAN; and receiving, by the UE device, packets of a protocol data unit (PDU) set of the media communication session originating from the second network device via the RAN.

The method of FIG. 5 also represents an example of a method of exchanging media data via a network, including: receiving, by a device executing a user plane function (UPF) and from a user equipment (UE) device, data representing a local Internet protocol (IP) address type and a maximum transmission unit (MTU) size for a second network device, wherein the device executing the UPF is within a radio access network (RAN) to which the UE device is communicatively coupled; receiving, by the device executing the UPF, a first data packet of a first protocol data unit (PDU); determining, by the device executing the UPF, that a source IP address of the first data packet matches an IP address of the second network device; adjusting, by the device executing the UPF, a PDU set size value (PSSize) value based on the local IP address type, the MTU size, and a number of PDUs for the first PDU; encapsulating, by the device executing the UPF, the first data packet in a GPRS tunneling protocol (GTP-U) packet; adding, by the device executing the UPF, the adjusted PSSize value to a header of the GTP-U packet; and sending, by the device executing the UPF, the GTP-U packet to the UE device via the RAN.

The following clauses summarize various examples of the techniques of this disclosure:

Clause 1: A method of exchanging media data via a network, the method comprising: receiving, by a first network device, data from a second network device including a local Internet protocol (IP) address type for the second network device and a maximum transmission unit (MTU) size for the second network device; sending, by the first network device, data representing the local IP address type and the MTU size for the second network device to a user plane function (UPF) device; and receiving, by the first network device, packets of a protocol data unit (PDU) set.

Clause 2: The method of clause 1, wherein receiving the data including the local IP address type comprises receiving one of a Real-time Transport Protocol (RTP) packet including an RTP header extension specifying the local IP address type for the second network device or a Session Description Protocol (SDP) message specifying the local IP address type for the second network device.

Clause 3: The method of any of clauses 1 and 2, wherein receiving the data including the MTU size comprises receiving one of a Real-time Transport Protocol (RTP) packet including an RTP header extension specifying the MTU size for the second network device or a Session Description Protocol (SDP) message specifying the MTU size for the second network device.

Clause 4: The method of any of clauses 2 and 3, wherein the RTP extension header includes data representing one or more of an end PDU of the PDU set, an end of data burst, a PDU set importance value for the PDU set, a PDU set sequence number for the PDU set, or a PDU set size (PSSize) value.

Clause 5: The method of any of clauses 1-4, wherein receiving the data including the MTU size comprises receiving a Session Description Protocol (SDP) message specifying the MTU size as an SDP attribute.

Clause 6: The method of clause 5, wherein the SDP attribute has a format comprising “a=mtu: <mtu-size>,” where mtu-size is the size of the MTU at the second network device.

Clause 7: The method of any of clauses 5 and 6, wherein the SDP attribute expresses the MTU size in bytes or in a multiple of bytes.

Clause 8: The method of any of clauses 1-7, wherein sending the data representing the local IP address type and the MTU size for the second network device to the UPF device comprises sending the data representing the local IP address type and the MTU size for the second network device to an application function (AF) device to cause the AF device to forward the data representing the local IP address type and the MTU size for the second network device to the UPF device.

Clause 9: The method of clause 1, wherein receiving the data including the local IP address type comprises receiving one of a Real-time Transport Protocol (RTP) packet including an RTP header extension specifying the local IP address type for the second network device or a Session Description Protocol (SDP) message specifying the local IP address type for the second network device.

Clause 10: The method of clause 9, wherein the RTP extension header includes data representing one or more of an end PDU of the PDU set, an end of data burst, a PDU set importance value for the PDU set, a PDU set sequence number for the PDU set, or a PDU set size (PSSize) value.

Clause 11: The method of clause 1, wherein receiving the data including the MTU size comprises receiving one of a Real-time Transport Protocol (RTP) packet including an RTP header extension specifying the MTU size for the second network device or a Session Description Protocol (SDP) message specifying the MTU size for the second network device.

Clause 12: The method of clause 11, wherein the RTP extension header includes data representing one or more of an end PDU of the PDU set, an end of data burst, a PDU set importance value for the PDU set, a PDU set sequence number for the PDU set, or a PDU set size (PSSize) value.

Clause 13: The method of clause 1, wherein receiving the data including the MTU size comprises receiving a Session Description Protocol (SDP) message specifying the MTU size as an SDP attribute.

Clause 14: The method of clause 13, wherein the SDP attribute has a format comprising “a=mtu: <mtu-size>,” where mtu-size is the size of the MTU at the second network device.

Clause 15: The method of clause 14, wherein the SDP attribute expresses the MTU size in bytes or in a multiple of bytes.

Clause 16: The method of clause 1, wherein sending the data representing the local IP address type and the MTU size for the second network device to the UPF device comprises sending the data representing the local IP address type and the MTU size for the second network device to an application function (AF) device to cause the AF device to forward the data representing the local IP address type and the MTU size for the second network device to the UPF device.

Clause 17: A method of exchanging media data via a network, the method comprising: receiving, by a device executing a user plane function (UPF) and from a first network device, data representing a local Internet protocol (IP) address type and a maximum transmission unit (MTU) size for a second network device; receiving, by the device, a first data packet of a first protocol data unit (PDU); determining, by the device, that a source IP address of the first data packet matches an IP address of the second network device; adjusting, by the device, a PDU set size value (PSSize) value based on the local IP address type, the MTU size, and a number of PDUs for the first PDU; encapsulating, by the device, the first data packet in a GPRS tunneling protocol (GTP-U) packet; adding, by the device, the adjusted PSSize value to a header of the GTP-U packet; and sending, by the device, the GTP-U packet to the first network device.

Clause 18: The method of clause 17, wherein receiving the data representing the local IP address type and the MTU size comprises receiving the local IP address type and the MTU size from a device executing an application function (AF) that received the local IP address type and the MTU size from the first network device.

Clause 19: A device for retrieving media data, the device comprising one or more means for performing the method of any of clauses 1-18.

Clause 20: The device of clause 19, wherein the one or more means comprise a processing system comprising one or more processors implemented in circuitry.

Clause 21: The apparatus of clause 19, wherein the device comprises at least one of: an integrated circuit; a microprocessor; or a wireless communication device.

Clause 22: A computer-readable storage medium having stored thereon instructions that, when executed, cause a processing system to perform the method of any of clauses 1-18.

Clause 23: A first network device for exchanging media data via a network, the first network device comprising: means for receiving data from a second network device including a local Internet protocol (IP) address type for the second network device and a maximum transmission unit (MTU) size for the second network device; means for sending data representing the local IP address type and the MTU size for the second network device to a user plane function (UPF) device; and means for receiving packets of a protocol data unit (PDU) set.

Clause 24: A device for exchanging media data via a network, the device executing a user plane function (UPF), the device comprising: means for receiving, from a first network device, data representing a local Internet protocol (IP) address type and a maximum transmission unit (MTU) size for a second network device; means for receiving a first data packet of a first protocol data unit (PDU); means for determining that a source IP address of the first data packet matches an IP address of the second network device; means for adjusting a PDU set size value (PSSize) value based on the local IP address type, the MTU size, and a number of PDUs for the first PDU; means for encapsulating the first data packet in a GPRS tunneling protocol (GTP-U) packet; means for adding the adjusted PSSize value to a header of the GTP-U packet; and means for sending the GTP-U packet to the first network device.

Clause 25: A method of exchanging media data via a network, the method comprising: receiving, by a user equipment (UE) device, data from a second network device via a radio access network (RAN), the data from the second network device including a local Internet protocol (IP) address type for the second network device and a maximum transmission unit (MTU) size for the second network device; establishing, by the UE device, a media communication session with the second network device; sending, by the UE device, data representing the local IP address type and the MTU size for the second network device to a user plane function (UPF) device of the RAN; and receiving, by the UE device, packets of a protocol data unit (PDU) set of the media communication session originating from the second network device via the RAN.

Clause 26: The method of clause 25, wherein receiving the data including the local IP address type and the MTU size comprises receiving one of a Real-time Transport Protocol (RTP) packet including an RTP header extension specifying the local IP address type for the second network device and the MTU size or a Session Description Protocol (SDP) message specifying the local IP address type for the second network device and the MTU size.

Clause 27: The method of clause 26, wherein the RTP extension header includes data representing one or more of an end PDU of the PDU set, an end of data burst, a PDU set importance value for the PDU set, a PDU set sequence number for the PDU set, or a PDU set size (PSSize) value.

Clause 28: The method of clause 25, wherein receiving the data including the MTU size comprises receiving a Session Description Protocol (SDP) message specifying the MTU size as an SDP attribute.

Clause 29: The method of clause 28, wherein the SDP attribute has a format comprising “a=mtu: <mtu-size>,” where mtu-size corresponds to the MTU size for the second network device.

Clause 30: The method of clause 28, wherein the SDP attribute expresses the MTU size in bytes or in a multiple of bytes.

Clause 31: The method of clause 25, wherein sending the data representing the local IP address type and the MTU size for the second network device to the UPF device comprises sending the data representing the local IP address type and the MTU size for the second network device to an application function (AF) device to cause the AF device to forward the data representing the local IP address type and the MTU size for the second network device to the UPF device.

Clause 32: A user equipment (UE) device for exchanging media data via a network, the UE device comprising: a memory configured to store media data; and a processing system comprising one or more processors implemented in circuitry, the processing system being configured to: receive data from a second network device via a radio access network (RAN), the data from the second network device including a local Internet protocol (IP) address type for the second network device and a maximum transmission unit (MTU) size for the second network device; establish a media communication session with the second network device; send data representing the local IP address type and the MTU size for the second network device to a user plane function (UPF) device of the RAN; and receive packets of a protocol data unit (PDU) set of the media communication session originating from the second network device via the RAN.

Clause 33: The UE device of clause 32, wherein to receive the data including the local IP address type and the MTU size, the processing system is configured to receive one of a Real-time Transport Protocol (RTP) packet including an RTP header extension specifying the local IP address type for the second network device and the MTU size or a Session Description Protocol (SDP) message specifying the local IP address type for the second network device and the MTU size.

Clause 34: The UE device of clause 33, wherein the RTP extension header includes data representing one or more of an end PDU of the PDU set, an end of data burst, a PDU set importance value for the PDU set, a PDU set sequence number for the PDU set, or a PDU set size (PSSize) value.

Clause 35: The UE device of clause 32, wherein to receive the data including the MTU size, the processing system is configured to receive a Session Description Protocol (SDP) message specifying the MTU size as an SDP attribute.

Clause 36: The UE device of clause 35, wherein the SDP attribute has a format comprising “a=mtu: <mtu-size>,” where mtu-size corresponds to the MTU size for the second network device.

Clause 37: The UE device of clause 35, wherein the SDP attribute expresses the MTU size in bytes or in a multiple of bytes.

Clause 38: The UE device of clause 32, wherein to send the data representing the local IP address type and the MTU size for the second network device to the UPF device, the processing system is configured to send the data representing the local IP address type and the MTU size for the second network device to an application function (AF) device of the RAN to cause the AF device to forward the data representing the local IP address type and the MTU size for the second network device to the UPF device.

Clause 39: A method of exchanging media data via a network, the method comprising: receiving, by a device executing a user plane function (UPF) and from a user equipment (UE) device, data representing a local Internet protocol (IP) address type and a maximum transmission unit (MTU) size for a second network device, wherein the device executing the UPF is within a radio access network (RAN) to which the UE device is communicatively coupled; receiving, by the device executing the UPF, a first data packet of a first protocol data unit (PDU); determining, by the device executing the UPF, that a source IP address of the first data packet matches an IP address of the second network device; adjusting, by the device executing the UPF, a PDU set size value (PSSize) value based on the local IP address type, the MTU size, and a number of PDUs for the first PDU; encapsulating, by the device executing the UPF, the first data packet in a GPRS tunneling protocol (GTP-U) packet; adding, by the device executing the UPF, the adjusted PSSize value to a header of the GTP-U packet; and sending, by the device executing the UPF, the GTP-U packet to the UE device via the RAN.

Clause 40: The method of clause 39, wherein receiving the data representing the local IP address type and the MTU size comprises receiving the local IP address type and the MTU size from a device executing an application function (AF) that received the local IP address type and the MTU size from the UE device.

Clause 41: A device executing a user plane function (UPF) of a radio access network (RAN), the device comprising: a memory configured to store network packets; and a processing system implemented in circuitry, the processing system being configured to: receive, from a user equipment (UE) device communicatively coupled to the RAN, data representing a local Internet protocol (IP) address type and a maximum transmission unit (MTU) size for a second network device; receive a first data packet of a first protocol data unit (PDU); determine that a source IP address of the first data packet matches an IP address of the second network device; adjust a PDU set size value (PSSize) value based on the local IP address type, the MTU size, and a number of PDUs for the first PDU; encapsulate the first data packet in a GPRS tunneling protocol (GTP-U) packet; add the adjusted PSSize value to a header of the GTP-U packet; and send the GTP-U packet to the UE device via the RAN.

Clause 42: The device of clause 41, wherein to receive the data representing the local IP address type and the MTU size, the processing system is configured to receive the local IP address type and the MTU size from a device executing an application function (AF) that received the local IP address type and the MTU size from the UE device.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code, and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A method of exchanging media data via a network, the method comprising:
receiving, by a user equipment (UE) device, data from a second network device via a radio access network (RAN), the data from the second network device including a local Internet protocol (IP) address type for the second network device and a maximum transmission unit (MTU) size for the second network device;
establishing, by the UE device, a media communication session with the second network device;
sending, by the UE device, data representing the local IP address type and the MTU size for the second network device to a gateway device associated with the RAN; and
receiving, by the UE device, packets of a protocol data unit (PDU) set of the media communication session originating from the second network device via the RAN.

2. The method of claim 1, wherein receiving the data including the local IP address type and the MTU size comprises receiving one of a Real-time Transport Protocol (RTP) packet including an RTP header extension specifying the local IP address type for the second network device and the MTU size or a Session Description Protocol (SDP) message specifying the local IP address type for the second network device and the MTU size.

3. The method of claim 2, wherein the RTP extension header includes data representing one or more of an end PDU of the PDU set, an end of data burst, a PDU set importance value for the PDU set, a PDU set sequence number for the PDU set, or a PDU set size (PSSize) value.

4. The method of claim 1, wherein receiving the data including the MTU size comprises receiving a Session Description Protocol (SDP) message specifying the MTU size as an SDP attribute.

5. The method of claim 4, wherein the SDP attribute has a format comprising “a=mtu: <mtu-size>,” where mtu-size corresponds to the MTU size for the second network device.

6. The method of claim 4, wherein the SDP attribute expresses the MTU size in bytes or in a multiple of bytes.

7. The method of claim 1, wherein sending the data representing the local IP address type and the MTU size for the second network device to the gateway device comprises sending the data representing the local IP address type and the MTU size for the second network device to an application function (AF) device to cause the AF device to forward the data representing the local IP address type and the MTU size for the second network device to the gateway device.

8. A user equipment (UE) device for exchanging media data via a network, the UE device comprising:
a memory configured to store media data; and
a processing system comprising one or more processors implemented in circuitry, the processing system being configured to:
receive data from a second network device via a radio access network (RAN), the data from the second network device including a local Internet protocol (IP) address type for the second network device and a maximum transmission unit (MTU) size for the second network device;
establish a media communication session with the second network device;
send data representing the local IP address type and the MTU size for the second network device to a gateway device associated with the RAN; and
receive packets of a protocol data unit (PDU) set of the media communication session originating from the second network device via the RAN.

9. The UE device of claim 8, wherein to receive the data including the local IP address type and the MTU size, the processing system is configured to receive one of a Real-time Transport Protocol (RTP) packet including an RTP header extension specifying the local IP address type for the second network device and the MTU size or a Session Description Protocol (SDP) message specifying the local IP address type for the second network device and the MTU size.

10. The UE device of claim 9, wherein the RTP extension header includes data representing one or more of an end PDU of the PDU set, an end of data burst, a PDU set importance value for the PDU set, a PDU set sequence number for the PDU set, or a PDU set size (PSSize) value.

11. The UE device of claim 8, wherein to receive the data including the MTU size, the processing system is configured to receive a Session Description Protocol (SDP) message specifying the MTU size as an SDP attribute.

12. The UE device of claim 11, wherein the SDP attribute has a format comprising “a=mtu: <mtu-size>,” where mtu-size corresponds to the MTU size for the second network device.

13. The UE device of claim 11, wherein the SDP attribute expresses the MTU size in bytes or in a multiple of bytes.

14. The UE device of claim 8, wherein to send the data representing the local IP address type and the MTU size for the second network device to the gateway device, the processing system is configured to send the data representing the local IP address type and the MTU size for the second network device to an application function (AF) device of the RAN to cause the AF device to forward the data representing the local IP address type and the MTU size for the second network device to the gateway device.

15. A method of exchanging media data via a network, the method comprising:
receiving, by a gateway device and from a user equipment (UE) device, data representing a local Internet protocol (IP) address type and a maximum transmission unit (MTU) size for a second network device, wherein the gateway device is within a radio access network (RAN) to which the UE device is communicatively coupled;
receiving, by the gateway device, a first data packet of a first protocol data unit (PDU);
determining, by the gateway device, that a source IP address of the first data packet matches an IP address of the second network device;
adjusting, by the gateway device, a PDU set size value (PSSize) value based on the local IP address type, the MTU size, and a number of PDUs for the first PDU;
encapsulating, by the gateway device, the first data packet in a GPRS tunneling protocol (GTP-U) packet;
adding, by the gateway device, the adjusted PSSize value to a header of the GTP-U packet; and
sending, by the gateway device, the GTP-U packet to the UE device via the RAN.

16. The method of claim 15, wherein receiving the data representing the local IP address type and the MTU size comprises receiving the local IP address type and the MTU size from a device executing an application function (AF) that received the local IP address type and the MTU size from the UE device.

17. A gateway device of a radio access network (RAN), the gateway device comprising:
a memory configured to store network packets; and
a processing system implemented in circuitry, the processing system being configured to:
receive, from a user equipment (UE) device communicatively coupled to the RAN, data representing a local Internet protocol (IP) address type and a maximum transmission unit (MTU) size for a second network device;
receive a first data packet of a first protocol data unit (PDU);
determine that a source IP address of the first data packet matches an IP address of the second network device;
adjust a PDU set size value (PSSize) value based on the local IP address type, the MTU size, and a number of PDUs for the first PDU;
encapsulate the first data packet in a GPRS tunneling protocol (GTP-U) packet;
add the adjusted PSSize value to a header of the GTP-U packet; and
send the GTP-U packet to the UE device via the RAN.

18. The device of claim 17, wherein to receive the data representing the local IP address type and the MTU size, the processing system is configured to receive the local IP address type and the MTU size from a device executing an application function (AF) that received the local IP address type and the MTU size from the UE device.
